(19) United States
(12) Patent Application Publication
(10) Pub. No.: US 2001/0002216 A1
(43) Pub. Date: May 31, 2001

(54) Imaging method and apparatus for generating a combined output image having image components taken at different focusing distances

(75) Inventors: Charles Chuang, Taipei Hsien (TW); Dustin Wen, Taipei Hsien (TW)

Correspondence Address: Merchant & Gould P.C., P.O. Box 2903, Minneapolis, MN, 55402-0903, US

(73) Assignee: Dynacolor, Inc.

(21) Appl. No.: 09/725,367

(22) Filed: Nov. 29, 2000

(30) Foreign Application Priority Data
Nov. 30, 1999 (TW) 088120888
Jan. 24, 2000 (TW) 088120888A01
Aug. 30, 2000 (TW) 088120888A02

(51) Int. Cl. G06K 9/40; G06K 9/36; G06K 9/00

(52) U.S. Cl. 382/255; 382/284; 382/162

(57) ABSTRACT

An imaging apparatus for generating a combined output image includes an image generating unit, and an image processing unit connected to the image generating unit. The image generating unit generates a plurality of input optical image data, each of which consists of an array of input image components and corresponds to an optical image of a scene taken at a respective focusing distance. The image processing unit processes the plurality of input optical image data to produce an output optical image data that consists of an array of output image components. The image processing unit calculates a neighborhood contrast value for each of the input image components of the plurality of input optical image data, compares the neighborhood contrast values of the input image components of the plurality of input optical image data that are located at a same position on the respective array, and selects the input image components that have optimal neighborhood contrast values in relation to the other ones of the input image components located at the same position on the respective array as the output image components of the output optical image data. An imaging method for generating the combined output image is also disclosed.

### BACKGROUND OF THE INVENTION

1. Field of the Invention

The invention relates to a method and apparatus for generating a combined output image, more particularly to a method and apparatus for generating a combined output image having image components taken at different focusing distances.

2. Description of the Related Art

A conventional imaging apparatus, such as a camera or a motion video recorder, usually includes a focusing unit for adjusting automatically or manually an imaging lens of the conventional imaging apparatus to generate an optical image of an object in a scene taken at an appropriate focusing distance. However, because focusing adjustment is conducted by taking into consideration only the desired object in the scene, the desired object is clear in the output optical image of the conventional imaging apparatus, while the background of the desired object in the output optical image is fuzzy due to inappropriate focusing. Furthermore, when light sources of different brightness, such as light during sunset and light from a flash, exist in the scene, the output optical image of the conventional imaging apparatus experiences different color temperatures at different portions thereof, thereby affecting the quality of the output optical image.

### SUMMARY OF THE INVENTION

Therefore, the object of the present invention is to provide an imaging method and apparatus for generating a combined output image having image components taken at different focusing distance so as to overcome the aforesaid drawback that is commonly associated with the prior art.

According to one aspect of the present invention, an imaging method is adapted to generate a combined output image, and includes the steps of:

(a) generating a plurality of input optical image data, each of which consists of an array of input image components and corresponds to an optical image of a scene taken at a respective focusing distance; and

(b) processing the plurality of input optical image data to produce an output optical image data that consists of an array of output image components, including the sub-steps of calculating a neighborhood contrast value for each of the input image components of the plurality of input optical image data, comparing the neighborhood contrast values of the input image components of the plurality of input optical image data that are located at a same position on the respective array, and selecting the input image components that have optimal neighborhood contrast values in relation to the other ones of the input image components located at the same position on the respective array as the output image components of the output optical image data. As such, the output optical image data corresponds to a combined optical image of the scene taken at different focusing distances.

According to another aspect of the present invention, an imaging apparatus is adapted to generate a combined output image, and includes image generating means and image processing means.

The image generating means generates a plurality of input optical image data, each of which consists of an array of input image components and corresponds to an optical image of a scene taken at a respective focusing distance.

The image processing means, which is connected to the image generating means, processes the plurality of input optical image data to produce an output optical image data that consists of an array of output image components. The image processing means calculates a neighborhood contrast value for each of the input image components of the plurality of input optical image data, compares the neighborhood contrast values of the input image components of the plurality of input optical image data that are located at a same position on the respective array, and selects the input image components that have optimal neighborhood contrast values in relation to the other ones of the input image components located at the same position on the respective array as the output image components of the output optical image data. As such, the output optical image data corresponds to a combined optical image of the scene taken at different focusing distance.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating the first preferred embodiment of an imaging apparatus according to this invention;

FIG. 2 is a schematic view illustrating how the first preferred embodiment captures a plurality of optical images of a scene taken at different focusing distances;

FIGS. 2A to 2C are schematic views showing the optical images of the scene taken at different focusing distances;

FIG. 2D is a schematic view showing an output optical image generated from the images of FIGS. 2A to 2C;

FIG. 3 is schematic view of an array of input image components generated by the first preferred embodiment;

FIG. 4 is a schematic circuit block diagram illustrating the second preferred embodiment of an imaging apparatus according to this invention;

FIG. 5 is a schematic circuit block diagram illustrating the third preferred embodiment of an imaging apparatus according to this invention;

FIG. 6 is a schematic circuit block diagram illustrating the fourth preferred embodiment of an imaging apparatus according to this invention;

FIG. 7 is schematic view of a cell array of a charge-coupled-device of the third preferred embodiment;

FIG. 8 is a schematic view illustrating how the fourth preferred embodiment captures a plurality of optical images of a scene taken at different focusing distances;

FIG. 9 is a schematic circuit block diagram illustrating the fifth preferred embodiment of an imaging apparatus according to this invention; and

FIG. 10 is a schematic circuit block diagram illustrating the sixth preferred embodiment of an imaging apparatus according to this invention.

### DETAILED DESCRIPTION OF THE PREFERRED EMBODIMENTS

Before the present invention is described in greater detail, it should be noted that like elements are denoted by the same reference numerals throughout the disclosure.

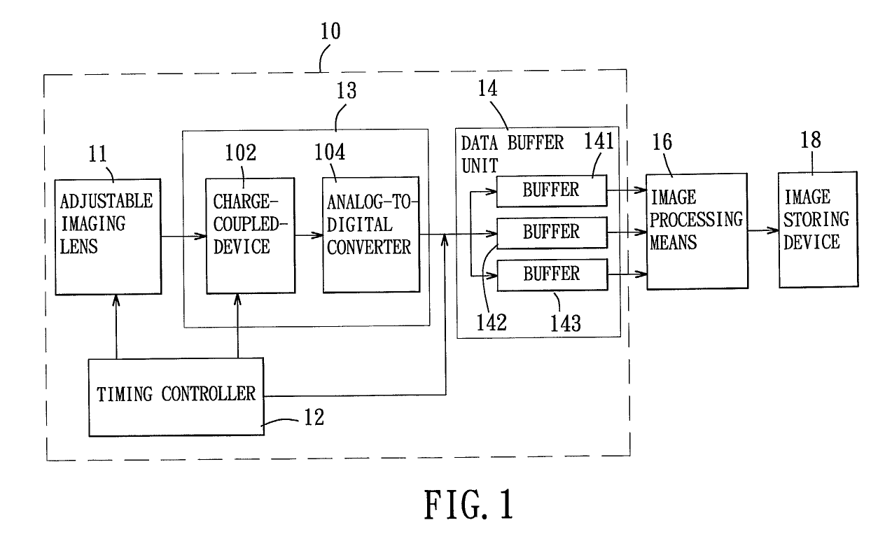

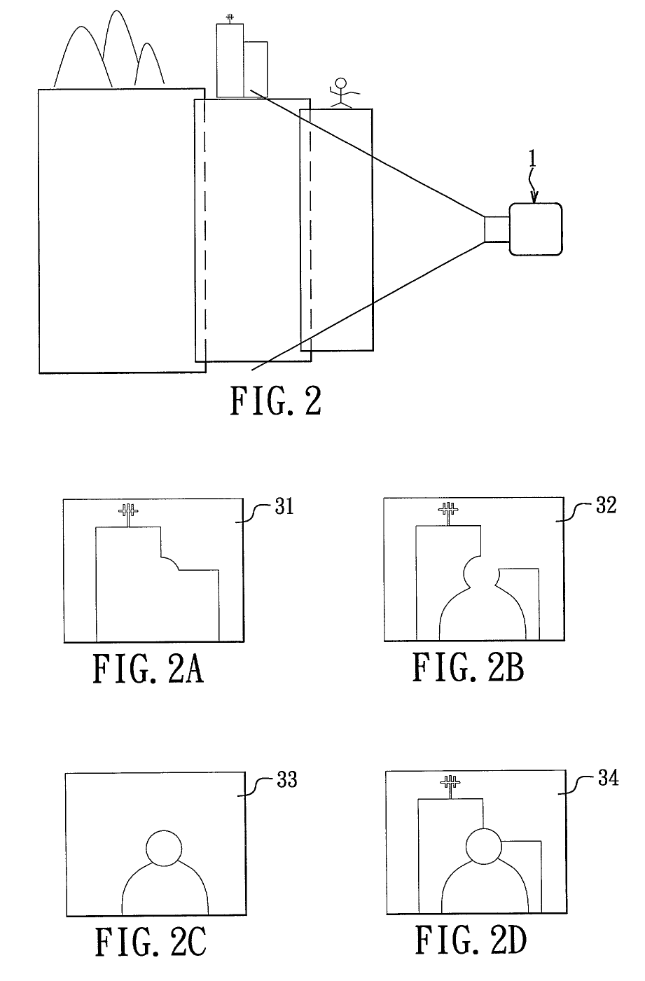

Referring to FIGS. 1 and 2, according to the first preferred embodiment of this invention, a static imaging apparatus, such as a camera 1, is shown to include image generating means 10, image processing means 16 connected to the image generating means 10, and an image storing device 18 coupled to the image processing means 16.

The image generating means 10 includes an adjustable imaging lens 11, sensing means 13 coupled to the imaging lens 11, a data buffer unit 14 connected to the sensing means 13, and a timing controller 12 coupled to the imaging lens 11, the sensing means 13 and the data buffer unit 14.

The imaging lens 11 is a known manually or automatically adjustable imaging lens that is operable so as to generate a plurality of optical images 31, 32, 33 (see FIGS. 2A to 2C) of a scene, such as one that includes a distant mountain, a house in front of the mountain, and a nearby object. The optical images 31, 32, 33 are taken at different focusing distances and at different image capturing times.

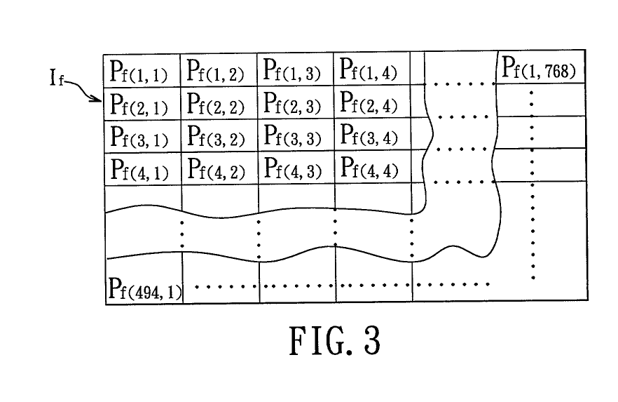

The sensing means 13 includes a charge-coupled-device 102 and an analog-to-digital converter 104 connected to the charge-coupled-device 102, and senses the optical images 31, 32, 33 from the imaging lens 11 to generate a plurality of input optical image data (Iₙ, Iₘ, I_{f}) during the different image capturing times, respectively. In this embodiment, each of the plurality of input optical image data (Iₙ, Iₘ, I_{f}) consists of a 494×768 array of input image components (P_{n(1,1)}, P_{n(1,2)}, . . . , P_{n(494,768)}; P_{m(1,1)}, P_{m(1,2)}, . . . , P_{m(494,768)}; P_{f(1,1)}, P_{f(1,2)}, . . . , P_{f(494,768)}, as shown in FIG. 3, and corresponds to one of the optical images 31, 32, 33 of the scene taken at the respective focusing distance.

The data buffer unit 14 includes a plurality of buffers 141, 142, 143, such as RAMs, for storing the plurality of input optical image data (Iₙ, Iₘ, I_{f}) therein, respectively.

The timing controller 12 controls the sensing operation of the sensing means 13 and the storage of the input optical image data (Iₙ, Iₘ, I_{f}) in the buffers 141, 142, 143.

The image processing means 16 processes the plurality of input optical image data (Iₙ, Iₘ, I_{f}) to produce an output optical image data (Iₒ) that consists of a 494×768 array of output image components (P_{o(1,1)}, P_{o(1,2)}, . . . , P_{o(494,768)}). Initially, the image processing means 16 calculates a neighborhood contrast value for each of the input image components (P_{n(1,1)}, P_{n(1,2)}, . . . , P_{n(494,768)}; P_{m(1,1)}, P_{m(1,2)}, . . . , P_{m(494,768)}; P_{f(1,1)}, P_{f(1,2)}, . . . , P_{f(494,768)} of the plurality of input optical image data (Iₙ, Iₘ, I_{f}). The image processing means 16 then compares the neighborhood contrast values of the input image components (P_{n(1,1)}, P_{n(1,2)}, . . . , P_{n(494,768)}; P_{m(1,1)}, P_{m(1,2)}, . . . , P_{m(494,768)}; P_{f(1,1)}, P_{f(1,2)}, . . . , P_{f(494,768)} of the plurality of input optical image data (Iₙ, Iₘ, I_{f}) that are located at a same position on the respective array. Finally, the image processing means 16 selects the input image components that have optimal or largest neighborhood contrast values in relation to the other ones of the input image components located at the same position on the respectively array as the output image components (P_{o(1,1)}, P_{o(1,2)}, . . . , P_{o(494,768)} of the output optical image data (Iₒ).

In the following example, the average of the absolute values of the differences between the input image component (P_{n(3,3)}) and the adjacent input image components (P_{n(1,1)}, P_{n(1,2)}, . . . , P_{n(5,5)}) on a 5×5 sub-array (a 3×3 sub-array can also be used to result in a faster processing speed) is the neighborhood contrast value for the input image component (P_{n(3,3)}).In the same manner, the neighborhood contrast values for the input image components (P_{m(3,3)}, P_{f(3,3)}) are also calculated. If the input image component (P_{f(3,3)}) has the largest neighborhood contrast value as compared to the input image components (P_{n(3,3)}, P_{m(3,3)}), the input image component (P_{f(3,3)}) is selected as the output image component (P_{o(3,3)}) of the output optical image data (Iₒ).

The image storing device 18 stores the output optical image data (Iₒ) therein. As such, an output image 34 (see FIG. 2D) can be generated according to the output optical image data (Iₒ) stored in the image storing device 18.

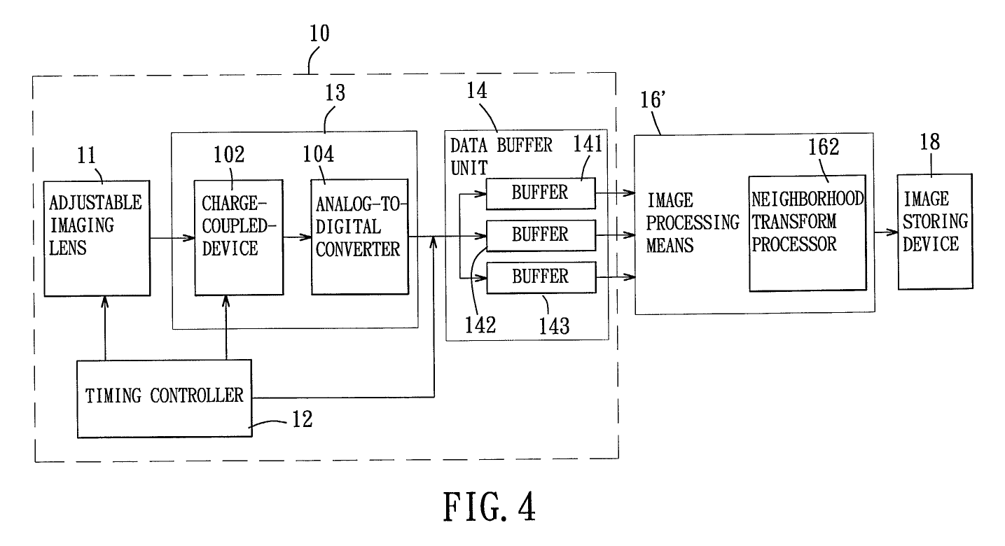

FIG. 4 illustrates the second preferred embodiment of an imaging apparatus according to this invention, which is a modification of the first preferred embodiment. Unlike the previous embodiment, the image processing means 16′ further includes a neighborhood transform processor 162 for applying neighborhood transform processing to the selected ones of the input image components (P_{n(1,1)}, P_{n(1,2)}, . . . , P_{n(494,768)}; P_{m(1,1)}, P_{m(1,2)}, . . . , P_{m(494,768)}; P_{f(1,1)}, P_{f(1,2)}, . . . , P_{f(494,768)} prior to storage in the image storing device 18. The neighborhood transform processor 162 is operative to perform an edge enhancement transform on the output optical image data (Iₒ) A typical example of the neighborhood transform processor 162 applicable in this embodiment is the one disclosed in U.S. Pat. No. 5,144,442.

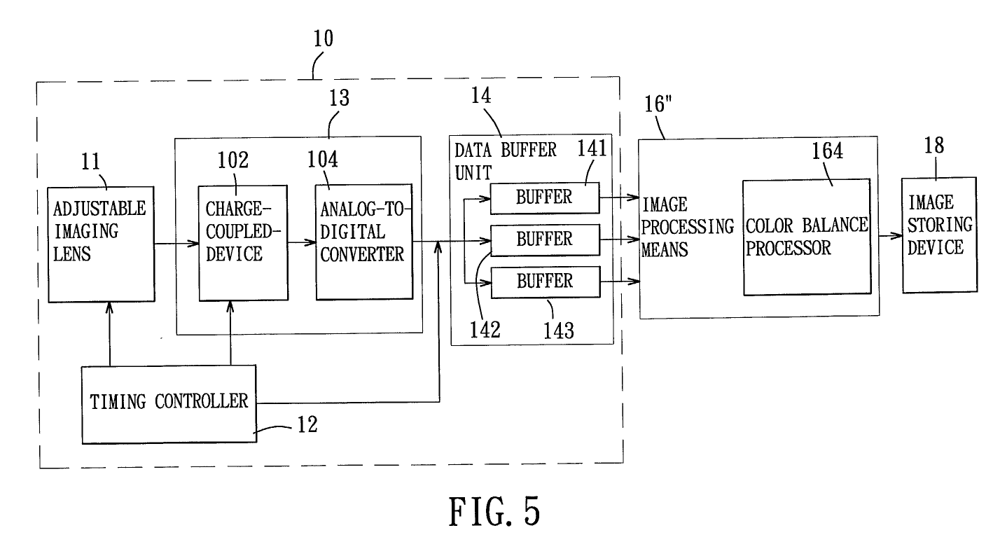

FIG. 5 illustrates the third preferred embodiment of an imaging apparatus according to this invention, which is a modification of the first preferred embodiment. Unlike the first preferred embodiment, the image processing means 16″ further includes a color balance processor 164 for applying color balance processing to the selected ones of the input image components (P_{n(1,1)}, P_{n(1,2)}, . . . , P_{n(494,768)}; P_{m(1,1)}, P_{m(1,2)}, . . . , P_{m(494,768)}; P_{f(1,1)}, P_{f(1,2)}, . . . , P_{f(494,768)} prior to storage in the image storing device 18. The color balance processor 164 is operable to perform color temperature compensation on the output optical image data (Iₒ)

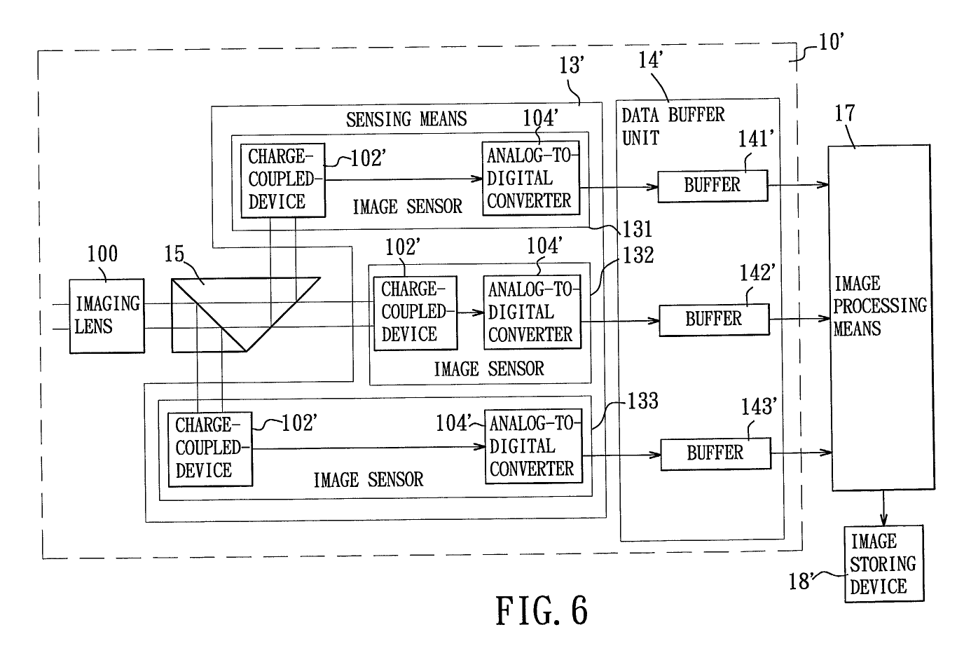

Referring to FIGS. 6 and 8, according to the fourth preferred embodiment of this invention, a dynamic imaging apparatus, such as a motion video recorder 1′, is shown to include image generating means 10′, image processing means 17 connected to the image generating means 10′, and an image storing device 18′ coupled to the image processing means 17.

The image generating means 10′ includes an imaging lens 100, an image splitting unit 15 associated operably with the imaging lens 100, sensing means 13′ coupled operably to the image splitting unit 15, and a data buffer unit 14′ connected to the sensing means 13′.

The imaging lens 100 is a known manually or automatically adjustable imaging lens that is operable so as to adjust a primary focusing distance and so as to generate an initial image 32′ of a scene taken at the primary focusing distance.

The image splitting unit 15 splits the initial image 32′ from the imaging lens 100 to obtain a plurality of optical images 31′, 32′, 33′ of the scene taken at different focusing distances.

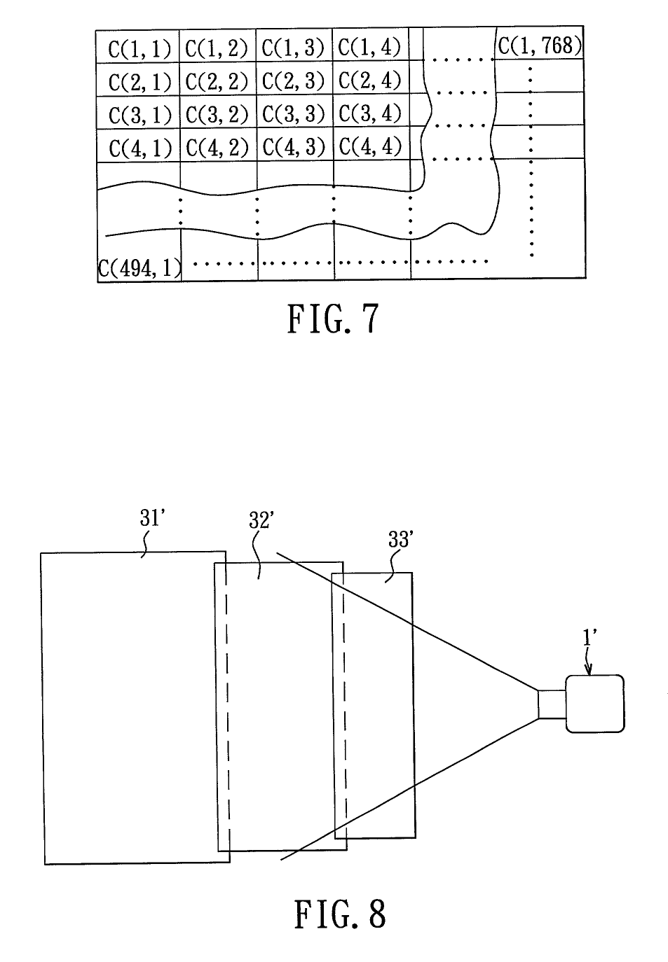

The sensing means 13′ includes a plurality of image sensors 131, 132, 133, each of which includes a charge-coupled-device 102′ and an analog-to-digital converter 104′ connected to the charge-coupled-device 102′. In this embodiment, each of the charge-coupled-devices 102′ has a494×768 array of cells (C_{(1,1)}, C_{(1,2)}, . . . , C_{(494,768)}, as shown in FIG. 7. According to the following formula:

$$\frac{1}{p} + \frac{1}{q} = \frac{1}{f}$$

the distance “p” between the object and the imaging lens, the distance “q” between the optical image and the imaging lens, and the focusing distance “f” of the imaging lens have a fixed relationship. Thus, due to the different optical paths between the image sensors 131, 132, 133 and the image splitting unit 15, the image sensors 131, 132, 133 are able to sense the optical images 33′, 32′, 31′ respectively and simultaneously to generate a plurality of input optical image data (I′ₙ, I′_{m, I′}_{f}). Each of the plurality of input optical image data (I′ₙ, I′ₘ, I′_{f}) consists of a 494×768 array of input image components (P′_{n(1,1)}, P′_{n(1,2)}, . . . , P′_{n(494,768)}; P′_{m(1,1)}, P′_{m(1,2)}, . . . , P′_{m(494,768)}; P′_{f(1,1)}, P′_{f(1,2)}, . . . , P′_{f(494,768)}, and corresponds to one of the optical images 33′, 32′, 31′ of the scene taken at the respective focusing distance.

The data buffer unit 14′ includes a plurality of buffers 141′, 142′, 143′, such as RAMs, for storing the plurality of input optical image data (I′ₙ, I′ₘ, I′_{f}) therein, respectively.

The image processing means 17 processes the plurality of input optical image data (I′ₙ, I′ₘ, I′_{f}) to produce an output optical image data (I′ₒ) that consists of a 494×768 array of output image components (P′_{o(1,1)}, P′_{o(1,2)}, . . . , P′_{o(494,768)}. Like the previous embodiments, the image processing means 17 initially calculates a neighborhood contrast value for each of the input image components (P′_{n(1,1)}, P′_{n(1,2)}, . . . , P′_{n(494,768)}; P′_{m(1,1)}, P′_{m(1,2)}, . . . , P′_{m(494,768)}; P′_{f(1,1)}, P′_{f(1,2)}, . . . , P′_{f(494,768)}) of the plurality of input optical image data (I′ₙ, I′ₘ, I′_{f}). The image processing means 17 then compares the neighborhood contrast values of the input image components (P′_{n(1,1)}, P′_{n(1,2)}, . . . , P′_{n(494,768)}; P′_{m(1,1)}, P′_{m(1,2)}, . . . , P′_{m(494,768)}; P′_{f(1,1)}, P′_{f(1,2)}, . . . , P′_{f(494,768)}) of the plurality of input optical image data (I′ₙ, I′ₘ, I′_{f}) that are located at a same position on the respective array. Thereafter, the image processing means 17 selects the input image components that have optimal or largest neighborhood contrast values in relation to the other ones of the input image components located at the same position on the respectively array as the output image components (P′_{o(1,1)}, P′_{o(1,2)}, . . . , P′_{o(494,768)}) of the output optical image data (I′ₒ). The image storing device 18 stores the output optical image data (I′ₒ) therein.

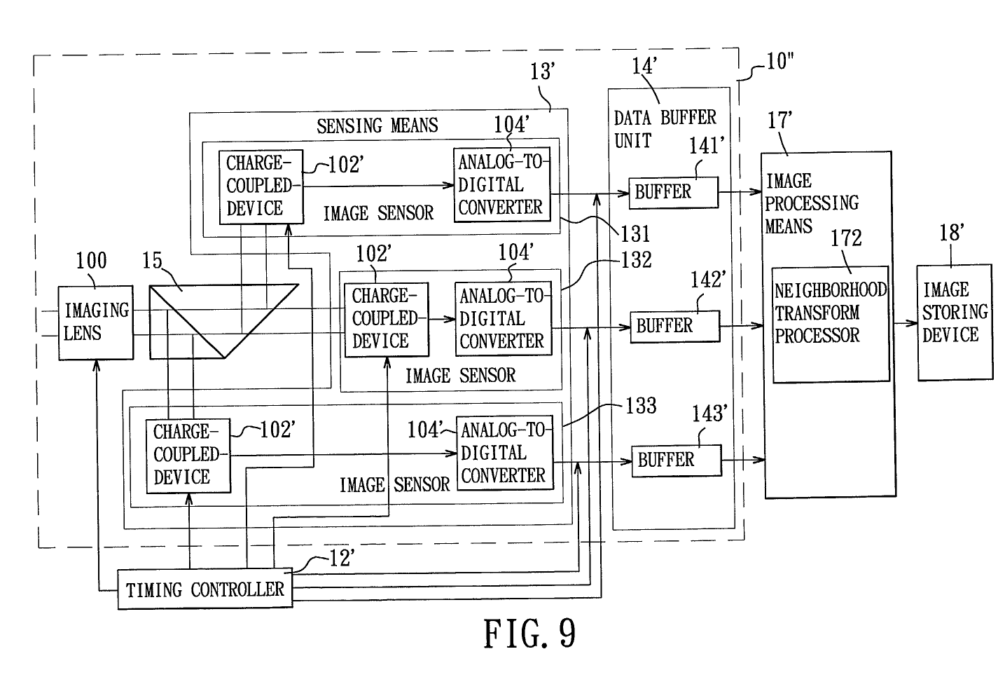

FIG. 9 illustrates the fifth preferred embodiment of a dynamic imaging apparatus according to this invention, which is a modification of the fourth preferred embodiment. Unlike the fourth preferred embodiment, the image generating means 10″ further includes a timing controller 12′ coupled to the imaging lens 100′, the sensing means 13′ and the data buffer unit 14′. The timing controller 12′ controls sensing operation of the sensing means 13′ and the storage of the input optical image data (I′ₙ, I′ₘ, I′_{f}) in the buffers 141′, 142′, 143′. The image processing means 17′ further includes a neighborhood transform processor 172, similar to the neighborhood transform processor 162 of the second preferred embodiment, for applying neighborhood transform processing to the selected ones of the input image components (P′_{n(1,1)}, P′_{n(1,2)}, . . . , P′_{n(494,768)}; P′_{m(1,1)}, P′_{m(1,2)}, . . . , P′_{m(494,768)}; P′_{f(1,1)}, P′_{f(1,2)}, . . . , P′_{f(494,768)}) prior to storage in the image storing device 18′.

It is noted that the imaging apparatus 1′ according to this invention can generate a plurality of input optical image data during an image capturing time. Thus, the adverse effect of a limited image capturing time on the capturing of a moving object in a scene can be minimized.

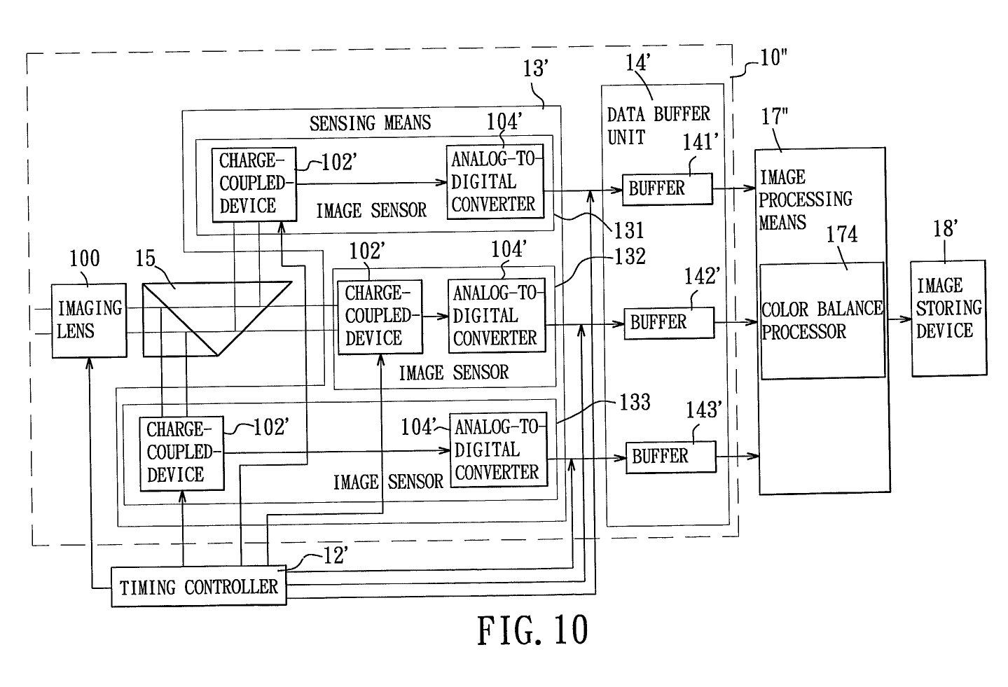

FIG. 10 illustrates the sixth preferred embodiment of a dynamic imaging apparatus according to this invention, which is a modification of the fifth preferred embodiment. Unlike the fifth preferred embodiment, the image processing means 17″ includes a color balance processor 174, similar to the color balance processor 164 of the third preferred embodiment, for applying color balance processing to the selected ones of the input image components (P′_{n(1,1)}, P′_{n(1,2)}, . . . , P′_{n(494,,768)}; P′_{m(1,1)}, P′_{m(1,2)}, . . . , P′_{m(494,768)}; P′_{f(1,1)}, P′_{f(1,2)}, . . . , P′_{f(494,768)} prior to storage in the image storing device 18′.

The output optical image data generated by the imaging apparatus of this invention corresponds to a combined optical image of the scene taken at different focusing distances, thereby ensuring sharpness, clarity and well-distributed color temperature throughout the combined optical image. The object of the invention is thus met.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An imaging method, comprising the steps of:
(a) generating a plurality of input optical image data, each of which consists of an array of input image components and corresponds to an optical image of a scene taken at a respective focusing distance; and
(b) processing the plurality of input optical image data to produce an output optical image data that consists of an array of output image components, including the sub-steps of calculating a neighborhood contrast value for each of the input image components of the plurality of input optical image data, comparing the neighborhood contrast values of the input image components of the plurality of input optical image data that are located at a same position on the respective array, and selecting the input image components that have optimal neighborhood contrast values in relation to the other ones of the input image components located at the same position on the respective array as the output image components of the output optical image data;
whereby, the output optical image data corresponds to a combined optical image of the scene taken at different focusing distances.

2. The imaging method of claim 1, wherein the step (a) includes the sub-steps of:
adjusting an imaging lens to generate a plurality of the optical images of the scene taken at the different focusing distances and at different image capturing times;
sensing the optical images from the imaging lens to generate the plurality of input optical image data during the different image capturing times, respectively; and
storing the plurality of input optical image data in a data buffer unit.

3. The imaging method of claim 2, wherein the data buffer unit includes a plurality of buffers for storing the plurality of input optical image data, respectively.

4. The imaging method of claim 2, wherein the imaging lens is adjusted automatically.

5. The imaging method of claim 2, wherein the imaging lens is adjusted manually.

6. The imaging method of claim 1, further comprising the step of storing the output optical image data in an image storage device.

7. The imaging method of claim 1, wherein the step (b) further includes the sub-step of applying neighborhood transform processing to the selected ones of the input image components.

8. The imaging method of claim 7, further comprising the step of storing the output optical image data in an image storage device.

9. The imaging method of claim 1, wherein the step (b) further includes the sub-step of applying color-balance processing to the selected ones of the input image components.

10. The imaging method of claim 9, further comprising the step of storing the output optical image data in an image storage device.

11. The imaging method of claim 1, wherein the step (a) includes the sub-steps of:
generating an initial image of the scene taken at a primary focusing distance;
splitting the initial image to obtain the plurality of the optical images of the scene taken at the different focusing distances;
simultaneously sensing the optical images to generate the plurality of input optical image data; and
storing the plurality of input optical image data in a data buffer unit.

12. The imaging method of claim 11, wherein the initial image is generated by an imaging lens.

13. The imaging method of claim 12, wherein the imaging lens is manually adjustable to adjust the primary focusing distance.

14. The imaging method of claim 12, wherein the imaging lens is automatically adjustable to adjust the primary focusing distance.

15. The imaging method of claim 11, wherein the optical images are sensed respectively and simultaneously by a plurality of image sensors.

16. The imaging method of claim 11, wherein the data buffer unit includes a plurality of buffers for storing the plurality of input optical image data, respectively.

17. An imaging apparatus comprising:
image generating means for generating a plurality of input optical image data, each of which consists of an array of input image components and corresponds to an optical image of a scene taken at a respective focusing distance; and
image processing means, connected to said image generating means, for processing the plurality of input optical image data to produce an output optical image data that consists of an array of output image components, said image processing means calculating a neighborhood contrast value for each of the input image components of the plurality of input optical image data, said image processing means comparing the neighborhood contrast values of the input image components of the plurality of input optical image data that are located at a same position on the respective array, said image processing means selecting the input image components that have optimal neighborhood contrast values in relation to the other ones of the input image components located at the same position on the respective array as the output image components of the output optical image data;
whereby, the output optical image data corresponds to a combined optical image of the scene taken at different focusing distances.

18. The imaging apparatus of claim 17, wherein said image generating means comprises:
an adjustable imaging lens for generating a plurality of the optical images of the scene taken at the different focusing distances and at different image capturing times;
sensing means, coupled to said imaging lens, for sensing the optical images from said imaging lens to generate the plurality of input optical image data during the different image capturing times, respectively; and
a data buffer unit, connected to said sensing means, for storing the plurality of input optical image data therein.

19. The imaging apparatus of claim 18, wherein said data buffer unit includes a plurality of buffers for storing the plurality of input optical image data, respectively.

20. The imaging apparatus of claim 19, wherein said image generating means further comprises a timing controller coupled to said imaging lens, said sensing means and said data buffer unit, said timing controller controlling sensing operation of said sensing means and storage of the input optical image data in said buffers.

21. The imaging apparatus of claim 18, wherein said imaging lens is automatically adjustable.

22. The imaging apparatus of claim 18, wherein said imaging lens is manually adjustable.

23. The imaging apparatus of claim 18, wherein said sensing means includes a charge-coupled-device and an analog-to-digital converter connected to said charge-coupled-device.

24. The imaging apparatus of claim 17, further comprising an image storing device, coupled to said image processing means, for storing the output optical image data therein.

25. The imaging apparatus of claim 17, wherein said image processing means includes a neighborhood transform processor for applying neighborhood transform processing to the selected ones of the input image components.

26. The imaging apparatus of claim 25, further comprising an image storing device, coupled to said image processing means, for storing the output optical image data therein.

27. The imaging apparatus of claim 17, wherein said image processing means includes a color balance processor for applying color balance processing to the selected ones of the input image components.

28. The imaging apparatus of claim 27, further comprising an image storing device, coupled to said image processing means, for storing the output optical image data therein.

29. The imaging apparatus of claim 17, wherein said image generating means comprises:
an imaging lens for generating an initial image of the scene taken at a primary focusing distance;
an image splitting unit, associated operably with said imaging lens, for splitting the initial image from said imaging lens to obtain the plurality of the optical images of the scene taken at the different focusing distances;
sensing means, coupled operably to said image splitting unit, for simultaneously sensing the optical images to generate the plurality of input optical image data; and
a data buffer unit, connected to said sensing means, for storing the plurality of input optical image data therein.

30. The imaging apparatus of claim 29, wherein said imaging lens is manually adjustable to adjust the primary focusing distance.

31. The imaging apparatus of claim 29, wherein said imaging lens is automatically adjustable to adjust the primary focusing distance.

32. The imaging apparatus of claim 29, wherein said sensing means includes a plurality of image sensors for sensing the optical images respectively and simultaneously.

33. The imaging apparatus of claim 32, wherein each of said image sensors includes a charge-coupled-device and an analog-to-digital converter connected to said charge-coupled-device.

34. The imaging apparatus of claim 29, wherein said data buffer unit includes a plurality of buffers for storing the plurality of input optical image data, respectively.
